(19) United States
(12) Patent Application Publication
(10) Pub. No.: US 2013/0158925 A1
(43) Pub. Date: Jun. 20, 2013

(54) COMPUTING DEVICE AND METHOD FOR CHECKING DIFFERENTIAL PAIR

(71) Applicants: YA-LING HUANG, Shenzhen City (CN); CHIA-NAN PAI, Tu-Cheng (TW); SHOU-KUO HSU, Tu-Cheng (TW)

(72) Inventors: YA-LING HUANG, Shenzhen City (CN); CHIA-NAN PAI, Tu-Cheng (TW); SHOU-KUO HSU, Tu-Cheng (TW)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/585,856

(22) Filed: Aug. 15, 2012

(30) Foreign Application Priority Data
Dec. 14, 2011 (CN) 201110418249.0

(51) Int. Cl. G06F 19/00; G01N 37/00

(52) U.S. Cl. 702/82

(57) ABSTRACT

A computer-based method and a computing device for checking differential pairs of a printed circuit board layout are provided. The computing device determines the via pitch between switching vias of a differential pair according to the coordinates of the centers of the switching vias, determines the via gap between the switching vias of adjacent two differential pairs according to the radius and the coordinates of the centers of the switching vias, and determines that the switching vias does not satisfy design standards if the via pitch does not fall in an input via pitch range, or the via gap does not fall in an input via gap range.

### BACKGROUND

1. Technical Field

Embodiments of the present disclosure relates to circuit simulating systems and methods, and more particularly, to a computing device and a method for checking the distance between switching vias of a differential pair and the distance between switching vias of two differential pairs in a printed circuit board (PCB) layout.

2. Description of related art

The first via distance between switching vias of a differential pair and the second via distance between switching vias of two differential pairs in a printed circuit board (PCB) layout has an important impact on signal integrity. Thus the first and second via distance in a printed circuit board (PCB) layout should satisfy design standards. However, checking whether the first and second via distances satisfy design standards are often done visually by a technician, which is not only time-consuming, but also error-prone.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram of one embodiment of a computing device for checking differential pairs of a PCB layout.

FIG. 2 is a block diagram of one embodiment of function modules of a check system in the computing device of FIG. 1.

FIG. 3 is a schematic view showing switching vias of differential pairs.

FIG. 4 is a schematic view of a check window provided by the check system of FIG. 2.

FIG. 5 is a flowchart of one embodiment of a method for checking differential pairs in a PCB layout.

### DETAILED DESCRIPTION

The disclosure, including the accompanying drawings in which like references indicate similar elements, is illustrated by way of examples and not by way of limitation. It should be noted that references to “an” or “one” embodiment in this disclosure are not necessarily to the same embodiment, and such references mean at least one.

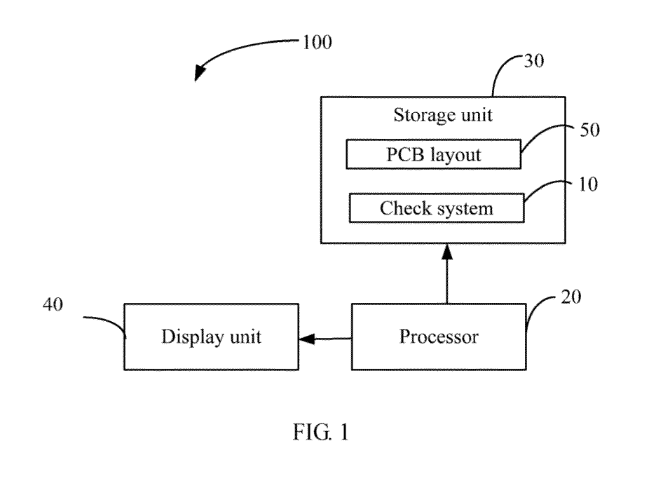

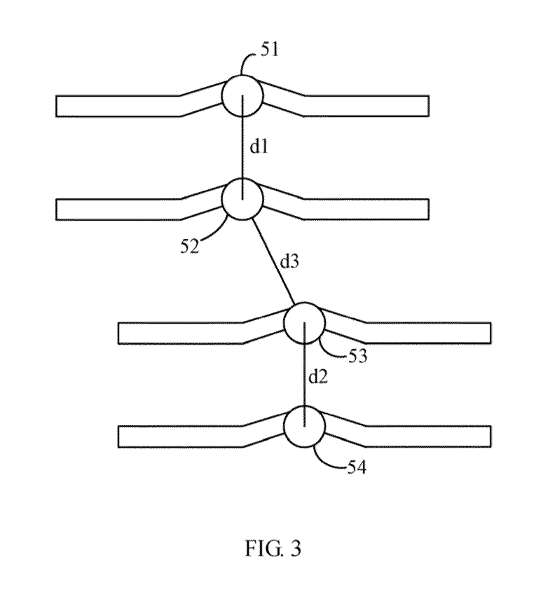

FIG. 1 is a block diagram of one embodiment of a computing device 10. The computing device 10 includes a processor 20, a storage unit 30, and a display unit 40. The storage unit 30 may be a computer, a smart media card, a secure digital card, or a flash card. The storage unit 30 stores computerized codes of a check system 10, at least one PCB layout 50, and an information file for each PCB layout 50. Each information file includes information for defining types of signal transmission lines, information for determining which via each signal transmission line is connected to, and the radius and coordinates of the center of each via. The check system 10 includes various software components and/or set of instructions, which may be implemented by the processor 20 to check whether each via pitch between switching vias of each differential pair (hereinafter via pitch) and each via gap between switching vias of two differential pairs (hereinafter via gap) satisfy design standards. In this embodiment, the via pitch is the center distance between the centers of the switching vias of a differential pair. The via gap is the center distance between the centers of two nearest switching vias of two differential pairs minus the total of the radius of the two nearest switching vias. As shown in FIG. 3, the center distance dl between the centers of the switching vias 51 and 52 of a differential pair is the via pitch between the switching vias 51 and 52. The center distance d2 between the centers of the switching vias 53 and 54 of a differential pair is the via pitch between the switching vias 53 and 54. The center distance d3 between the centers of the switching vias 52, 53 of two differential pairs minus the total of the radius of the switching vias 52, 53 is the via gap between the switching vias 52 and 53.

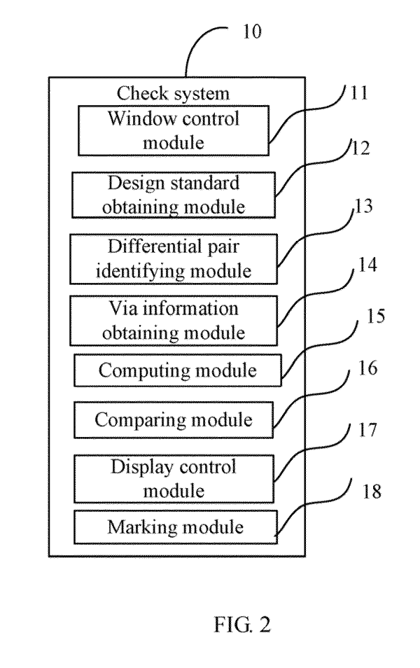

FIG. 2 is a block diagram of the function modules of the check system 10 in the computing device 100 of FIG. 1. In one embodiment, the check system 10 includes a window control module 11, a design standard obtaining module 12, a differential pair identifying module 13, a via information obtaining module 14, a computing module 15, a comparing module 16, a display control module 16, and a marking module 17.

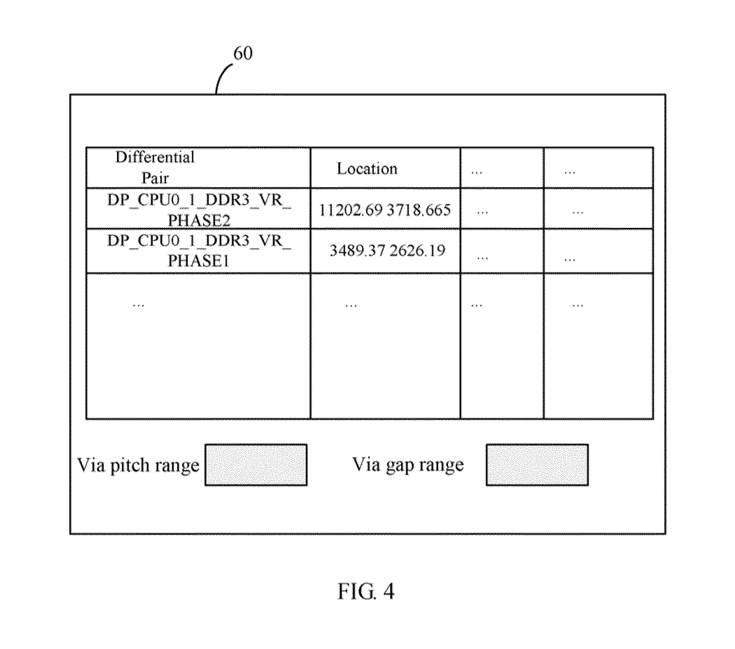

The window control module 11 includes various software components and/or set of instructions, which may be implemented by the processor 20 to display a check window 60 (see FIG. 4) on the display unit 40 for users to input a via pitch range each via pitch should fall into and a via gap range each via gap should fall into.

The design standard obtaining module 12 includes various software components and/or set of instructions, which may be implemented by the processor 20 to receive the via pitch range and the via gap range input through the check window 60.

The differential pair identifying module 13 includes various software components and/or set of instructions, which may be implemented by the processor 20 to identify differential pairs in a currently run PCB layout 50 according to the types of signal transmission lines defined in the information file for the currently run PCB layout 50.

The via information obtaining module 14 includes various software components and/or set of instructions, which may be implemented by the processor 20 to obtain the radius and the coordinates of the centers of the switching vias according to the information file for the currently run PCB layout.

The computing module 15 includes various software components and/or set of instructions, which may be implemented by the processor 20 to determine each via pitch according to the coordinates of the centers of the switching vias of each differential pair, and determine each via gap according to the radius and the coordinates of the centers of the switching vias of each two differential pairs. The detailed method of determining the via gap is described as follows: the computing module 15 is implemented to determine each center distance between the centers of each two switching vias of each adjacent two differential pairs, then determine two switching vias which center distance is shortest, and determine the via gap between the two determined switching vias by taking the total of the radius of the two determined switching vias from the center distance between the centers of the two determined switching vias.

The comparing module 16 includes various software components and/or set of instructions, which may be implemented by the processor 20 to determine the switching vias that does not satisfy the design standards. If the via pitch is not within the via pitch range, or the via gap is not within the pitch range, the comparing module 16 is implemented to determine that the switching vias does not satisfy design standards.

The display control module 17 includes various software components and/or set of instructions, which may be implemented by the processor 20 to display information related to the switching vias that does not satisfy design standard on the check window 60 (see FIG. 4). The information may include the name and the location of differential pairs which switching vias does not satisfy design standards.

The marking module 18 includes various software components and/or set of instructions, which may be implemented by the processor 20 to mark each switching via that does not satisfy design standards in the currently displayed PCB layout, for example, highlight each switching via that does not satisfy design standards in the currently displayed PCB layout.

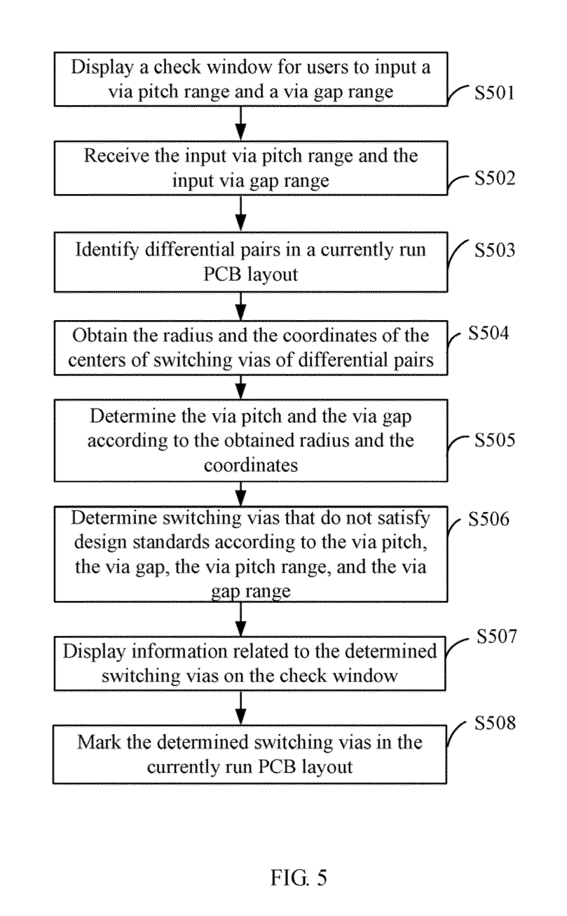

FIG. 5 is a flowchart of one embodiment of a method for checking differential pairs of a PCB layout. Depending on the embodiment, additional blocks may be added, others removed, and the ordering of the blocks may be changed.

In block S501, the window control module 11 is implemented by the processor 20 to display the check window 60 on the display unit 40 for users to input a via pitch range each via pitch should fall into and a via gap range each via gap should fall into.

In block S502, the design standard obtaining module 12 is implemented by the processor 20 to receive the via pitch range and the via gap range input through the check window 60.

In block S503, the differential pair identifying module 12 is implemented by the processor 20 to identify differential pairs in a currently run PCB layout 50 according to the types of signal transmission lines defined in the information file for the currently run PCB layout 50.

In block S504, the via information obtaining module 14 is implemented by the processor 20 to obtain the radius and the coordinates of the centers of the switching vias of differential pairs according to the information file for the currently run PCB layout.

In block S505, the computing module 15 is implemented by the processor 20 to determine each via pitch according to the coordinates of the centers of the switching vias of each differential pair, and determine each via gap according to the radius and the coordinates of the centers of the switching vias of each differential pair.

In block S506, the comparing module 16 is implemented by the processor 20 to determine the switching vias that does not satisfy the design standards. If the via pitch is not within the pitch range, or the via gap is not within the gap range, the comparing module 16 is implemented to determine that switching vias does not satisfy design standards.

In block S507, the display control module 17 includes various software components and/or set of instructions, which may be implemented by the processor 20 to display information related to the switching vias that does not satisfy design standard on the check window 60.

In block S508, the marking module 18 is implemented by the processor 20 to mark each switching via that does not satisfy design standards in the currently displayed PCB layout.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computer-based method for checking differential pairs of a printed circuit board (PCB) layout, the method comprising:
displaying a check window for users to input a via pitch range each via pitch between switching vias of each of differential pairs in the PCB layout should fall into and a via gap range each via gap between switching vias of each adjacent two of the differential pairs should fall into;
receiving the via pitch range and the via gap range input through the check window;
identifying differential pairs in the PCB layout according to an information file for the PCB layout;
obtaining the radius and the coordinates of the centers of the switching vias of each of the differential pairs according to the information file for the PCB layout;
determining each via pitch between the switching vias of each of the differential pairs according to the coordinates of the centers of the switching vias, and determining each via gap between the switching vias of each adjacent two of the differential pairs according to the radius and the coordinates of the centers of the switching vias;
determining that the switching vias of one of the differential pairs does not satisfy design standards if the via pitch between the switching vias of the one of the differential pairs does not fall in the via pitch range, and determining that the switching vias of adjacent two of the differential pairs does not satisfy design standards if the via gap between the switching vias of the adjacent two of the differential pairs does not fall in the via gap range; and
displaying information related to the switching vias that does not satisfy design standards on the check window.

2. The method as claimed in claim 1, further comprising:
marking the switching vias that does not satisfy design standards in the PCB layout.

3. The method as claimed in claim 1, wherein the information file corresponding to the PCB layout comprises information for defining types of signal transmission lines, information for determining which via each signal transmission line is connected to, and the radius and the coordinates of the center of each via in the PCB layout.

4. The method as claimed in claim 1, wherein the step of determining each via pitch between the switching vias of each of the differential pairs according to the coordinates of the centers of the switching vias, and determining each via gap between the switching vias of each two of the differential pairs according to the radius and the coordinates of the centers of the switching vias comprises: determining the center distance between the centers of the switching vias of each of the differential pairs is the via pitch, and determining the center distance between the centers of two nearest switching vias of each two of the differential pairs minus the total of the radius of the two nearest switching vias is the via gap.

5. A computing device for checking differential pairs of a printed circuit board (PCB) layout, comprising:
a storage device;
at least one processor; and
a check system comprising computerized code in the form of one or more programs, which are stored in the storage device and executable by the at least one processor, the one or more programs comprising:
a window control module operable to display a check window for users to input a via pitch range each via pitch between switching vias of each of differential pairs in the PCB layout should fall into and a via gap range each via gap between switching vias of each adjacent two of the differential pairs should fall into;
a design standard obtaining module operable to receive the via pitch range and the via gap range input through the check window;
a differential pair identifying module operable to identify differential pairs in the PCB layout according to an information file for the PCB layout;
a via information obtaining module operable to obtain the radius and the coordinates of the centers of the switching vias of each of the differential pairs according to the information file for the PCB layout;
a computing module operable to determine each via pitch between the switching vias of each of the differential pairs according to the coordinates of the centers of switching vias, and determine each via gap between the switching vias of each adjacent two of the differential pairs according to the radius and the coordinates of the centers of switching vias;
a comparing module operable to determine that the switching vias of one of the differential pair does not satisfy design standards if the via pitch between the switching vias of the one of the differential pairs does not fall in the via pitch range, and determine that the switching vias of adjacent two of the differential pairs does not satisfy design standards if the via gap between the switching vias of the adjacent two of differential pairs does not fall in the via gap range; and
a display control module operable to display information related to the switching vias that does not satisfy design standards on the check window.

6. The computing device as claimed in claim 5, wherein the one or more programs further comprise a marking module operable to mark the switching vias that does not satisfy design standards in the PCB layout.

7. The computing device as claimed in claim 5, wherein the information file corresponding to the PCB layout comprises information for defining types of signal transmission lines, information for determining which via each signal transmission line is connected to, and the radius and the coordinates of the center of each via in the PCB layout.

8. The computing device as described in claim 5, wherein the comparing module is operable to determine the center distance between the centers of the switching vias of each of the differential pairs is the via pitch, and determine the center distance between the centers of two nearest switching vias of each two of the differential pairs minus the total of the radius of the two nearest differential vias is the via gap.
